(19) United States
(12) Patent Application Publication
(10) Pub. No.: US 2008/0307225 A1
(43) Pub. Date: Dec. 11, 2008

(54) Method For Locking on to Encrypted Communication Connections in a Packet-Oriented Network

(76) Inventors: Jens-Uwe Busser, Munchen (DE); Gerald Liebe, Strausberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/883,466

(22) PCT Filed: Jan. 31, 2006
(86) PCT No.: PCT/EP06/50546

§ 371 Date: Aug. 21, 2008

(30) Foreign Application Priority Data
Feb. 1, 2005 (DE) 10 2005 004 612.6

(51) Int. Cl. H04L 9/06

(52) U.S. Cl. 713/171

(57) ABSTRACT

There is described a method for locking on or legal interception of encrypted communication connections, preferably in a peer-to-peer network. If all users in a communication network have a digital certificate, a good authentication and an end-to-end encryption of communication data is possible. A modification of network elements is disclosed to nevertheless provide legal tapping from authorized positions. The above can be used on a special tapping mode, in which the keys for all incoming and outgoing messages are provided to an authorized control position.

### CROSS REFERENCE TO RELATED APPLICATIONS

This application is the US National Stage of International Application No. PCT/EP2006/050546, filed Jan. 31, 2006 and claims the benefit thereof. The International Application claims the benefits of German application No. 10 2005 004 612.6 DE filed Feb. 01, 2005, both of the applications are incorporated by reference herein in their entirety.

### FIELD OF THE INVENTION

The invention relates to a method for locking-on to encrypted communication connections and a network element.

### BACKGROUND OF THE INVENTION

The term “legal interception” should be understood to mean a feature of public communication networks which allows authorized government bodies to lock on to communication connections and to tap the communication taking place over this communication connection. Hereby, the term communication covers both real-time connections, for example for voice and/or video communication, and non-real-time connections such as, for example, facsimile transmission, electronic post or email messaging services, commonly also referred to “chat”, etc.

Known from the prior art are decentralized networks, in which a majority of connected networks offer functions and services to other network elements and, on the other hand, can use functions and services offered by other network elements, without a central controlling entity having to be provided for this. In other words, a network element of this kind takes on either a role as a server or a role as a client vis-à-vis another network element on a case-by-case basis. A network element connected to the decentralized network is often also referred to as a “peer” to differentiate it from a usual client-server arrangement. Consequently, decentralized networks are also known as peer-to-peer networks or P2P networks for short.

### SUMMARY OF INVENTION

The delimiting definition of a decentralized network does not generally exclude the possibility of the presence of central entities. The term decentralized network or P2P network also refers to mixed forms of networks with which specific tasks are moved to a central entity or server, as long as these networks do not contain any servers via which any communication relationship can be performed between two network elements.

Also known are communication systems using a security infrastructure which is also described as a “public key infrastructure”, PKI, among experts. A PKI is understood to mean an environment in which services for the encryption of messages and for checking digital signatures are provided using a public key.

With a security infrastructure-of this kind, all users of a communication system have a digital certificate binding a public key to their identity. All users also have a private key corresponding to their public key which the users in question keep secret. The digital certificate of the user in question is generated by a third body, a so-called certification entity or certificate authority, CA, or even a trusted third party, TTP, with the corresponding identification features of the users.

The security infrastructure offers a trusted network environment, in which a communication is protected against unauthorized access by encryption and the authenticity of the communication partner is guaranteed by the use and evaluation of a digital signature.

Usually, so-called end-to-end encryption is used for confidential communication between two users. Here, data to be exchanged is first symmetrically encoded with a session key at a transmitting user A. This session key is then encrypted with the public key of a receiving user B and sent to this user B. Optionally, this session key is generated anew for each message and notified anew to the receiving user B in each case.

The following explains end-to-end encryption with reference to an encrypted communication method for a non-real-time communication. A non-real-time-communication occurs for example in the case of an encrypted email transmission.

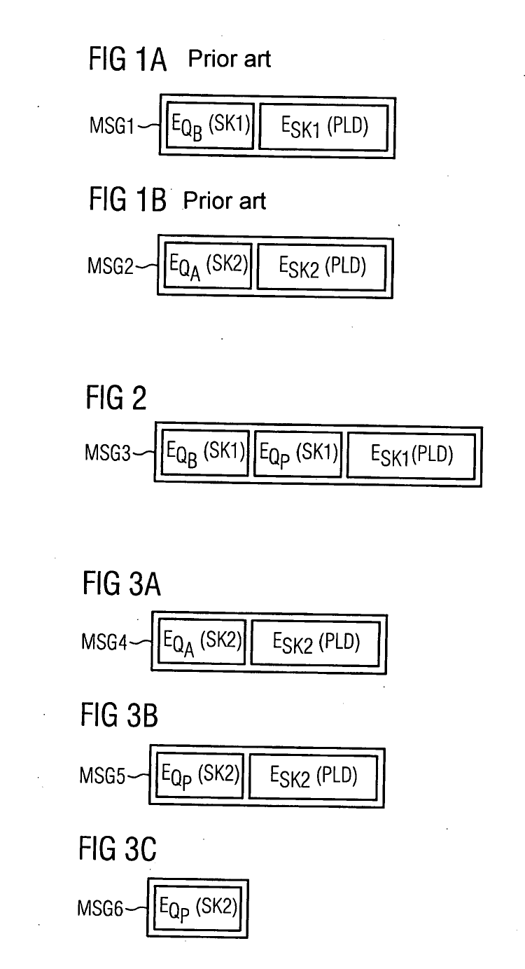

With reference to FIG. 1A, it is first assumed that a message MSG1 is sent by a first user A. A first session key SK1 is asymmetrically encrypted by the transmitting first user A with a public key Q_{B} of the receiving-second user B. The reference letter E here means an encryption operation.

Communication data (PLD), which contains for example the actual message text of an email, is encrypted with the first session key SK1. Both components are then transmitted to a receiving user B. Optionally, the message MSG1 can also be digitally signed by the transmitting user A so that the receiving user B is able to check the authenticity of the message.

In the event that a message is to be sent to several receiving users, the session key in question should be encrypted for all recipients with their respective public keys.

FIG. 1B shows a message MSG2 sent by the second user B. A second session key SK2 is asymmetrically encrypted by the transmitting second user B with a public key QA of the receiving second user A. Therefore, as explained above, here a new second session key SK2 is generated for the second message MSG2 and notified anew to the receiving user A.

The following explains a method for real-time communication, for example a telephone call between two communication partners using end-to-end encryption. For the encryption of the communication, usually during the establishment of a communication connection, a common session key is dynamically negotiated, for example by means of a so-called Diffie-Hellman method with authentication.

For the performance of this method, both communication partners select a secret random number and calculate a one-way function with suitable parameters which are the same for both communication partners. The intermediate result obtained in this way is then sent to the communication partner in each case. Both communication partners calculate a session key from this which is identical for both communication partners. This session key cannot be calculated by third parties since to do this it is necessary to know at least one of the two random numbers. To avoid “man-in-the-middle” attacks, exchanged messages of the communication partner in question are digitally signed in order to guarantee the authenticity of the communication partner in question.

This already known end-to-end encryption is characterized in that even intermediary network elements for the transportation of the message have no access to the plain text of the communication data (PLD). The communication therefore takes place confidentially between authenticated communication partners.

The advantage of confidentiality is found to be detrimental in cases when a central body in the communication system—for example a so-called service provider—is itself unable to decrypt communication data when it is legally obliged to do so, in particular when it has been instructed to perform or assist with the legal interception mentioned in the introduction by an appropriate authority.

In the case of services such as email or Voice over IP (VoIP), it is difficult to implement legal interception of this kind since the service provider does not usually have access to the locally installed software of the individual network elements. This situation is different in cases when the service provider itself offers a VoIP service which in principle offers the possibility of legal interception. In such cases, the service provider can be legally obliged to provide a method for legal interception.

Legal interception is also difficult to impossible with real-time communication in a PKI environment. To enable an authorized body to access encrypted communication connections, it has been proposed that all users in a communication system should be obliged to deposit their private key with a trusted party. However, a measure of this kind would cast doubt on the protected communication desired with a security infrastructure, since, with access to stored private keys in the trusted party, effective control, for example by courts, would not be guaranteed.

Therefore, it is the object of the invention to provide improved means for the locking-on of authorized bodies to encrypted communication connections while simultaneously safeguarding the security infrastructure.

The object is achieved by a method and a network element as claimed in independent claims. The object is also achieved by a computer program product

The invention is based on the consideration of facilitating the locking-on by authorized bodies without the private keys of the network elements connected with a packet-oriented network (for example communication terminals, computer systems, mobile computer units such as personal digital assistants, PDAs, etc) having to be deposited with a central body. The method according to the invention is facilitated by a change in the software of the participating network elements. According to the invention, the network elements are switched to a tapping mode during the course of which they notify the session keys of incoming and outgoing messages to an authorized control body.

For example, the invention is based on an environment in which users of a communication network have a digital certificate and hence good authentication and end-to-end encryption of communication data is possible.

The method according to the invention is based on a—to be established or already existing—encrypted communication connection of at least one first network element with at least one second network element. Hereby, the encryption is—for example but not necessarily—end-to-end encryption. Encryption of this kind is performed in the following steps:

a) establishment of a session key between the first network element and the second network element. For performance reasons, the use of this session key takes place in the form of a symmetrical session key, i.e. a key, which is used by both the transmitting and the receiving side.

b) encryption of a message to be transmitted—that is, for example, real-time data in the case of a telephone conversation or also non-real-time data, for example a text message—with the session key,

c) encryption of the session key with a public key assigned to the second network element for the purposes of an asymmetrical encryption,

d) creation of a message from the message content encrypted with the session key according to b) and the asymmetrically encrypted session key according to c) and transmission of the message from the transmitting first network element to the receiving second network element.

According to the invention, in the event of the receipt of a request from of a third network element—in particular a computer system of an executive authority performing a locking-on,—the first network element now switches to a tapping mode. This tapping mode takes place without the knowledge of the users participating in the communication who are to be tapped. In this mode it is provided that in the message according to step d), a result of an encryption of the session key with a public key assigned to the third network element is inserted and/or added to the message.

Whether an insertion or an addition is the more advantageous is determined by the type of encryption or the real-time character of the communication. Encryption with the public key assigned to the third network element guarantees that only the executive authority can perform the decryption of the session key by a private key corresponding to that assigned to the third network element. By means of intermediary node devices, it is simple to achieve an interception of the message modified in this way due to the packet-oriented nature of the network.

A substantial advantage of the method according to the invention can be seen in the fact that legal tapping by authorized bodies is facilitated without the deposition of the private key in question for each network element.

A further advantage of the method according to the invention can be seen in the fact that the method according to the invention can be implemented in the software for connection to a peer-to-peer-network, which enables the inevitable support of the method on all network elements participating in the peer-to-peer-network to be guaranteed. This enables the network operator of the peer-to-peer-network to prove the implementation of legal instructions which are therefore implemented without any great effort.

A further advantage lies in the difficulty for a tapped entity to identify the tapping process when the method according to the invention is used.

Since the controlling peer is a peer which otherwise works in the usual manner and-hierarchy, for the implementation of the method according to the invention, advantageously no changes in the architecture of the network and no further interventions in the software of network elements are required.

Advantageous further embodiments of the invention are disclosed in the subclaims.

An advantageous embodiment of the invention in particular for non-real-time communication provides for the establishment of the session key a definition of the session key by the first network element and a transmission of the session key to the second network element.

An advantageous embodiment of the invention in particular for real-time communication provides for the establishment of the session key a negotiation of the session key between the communication partners using the Diffie-Hellman method.

The means according to the invention provide particular advantages in a decentralized network with a peer-to-peer-architecture. In networks of this kind, due to the lack of a central communication node it is simply not possible to use conventional means for legal interception known to switching centers. The means according to the invention on the other hand facilitate access to an otherwise decentralized architecture.

An example with further advantages and embodiments of the invention are described in more detail in the following with reference to the drawings, which show:

FIG. 1A: a structural diagram for the schematic representation of an encrypted message sent by a user according to the prior art

FIG. 1B: a structural diagram for the schematic representation of an encrypted message received by a user according to the prior art

FIG. 2: a structural diagram for the schematic representation of an encrypted message sent by an intercepted user

FIG. 3A a structural diagram for the schematic representation of an encrypted message received by an intercepted user

FIG. 3B: a structural diagram for the schematic representation of an encrypted message sent by an intercepted user according to a first embodiment

FIG. 3C: a structural diagram for the schematic representation of an encrypted message sent by an intercepted user according to a second embodiment

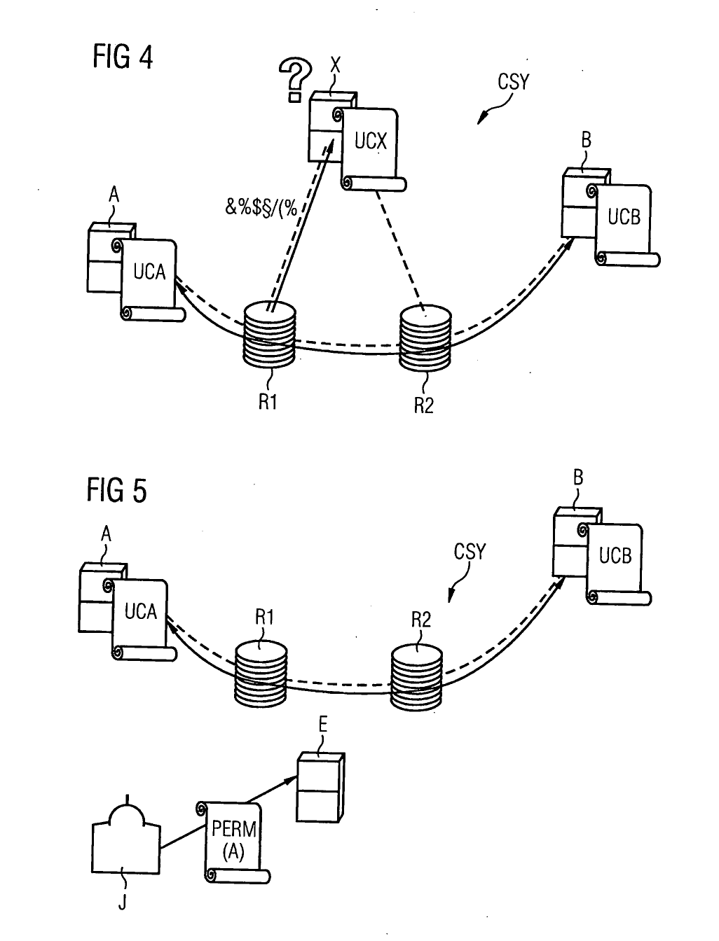

FIG. 4: a structural diagram for the schematic representation of an intercepted exchange of messages in a first phase

FIG. 5: a structural diagram for the schematic representation of a intercepted exchange of messages in a second phase, and

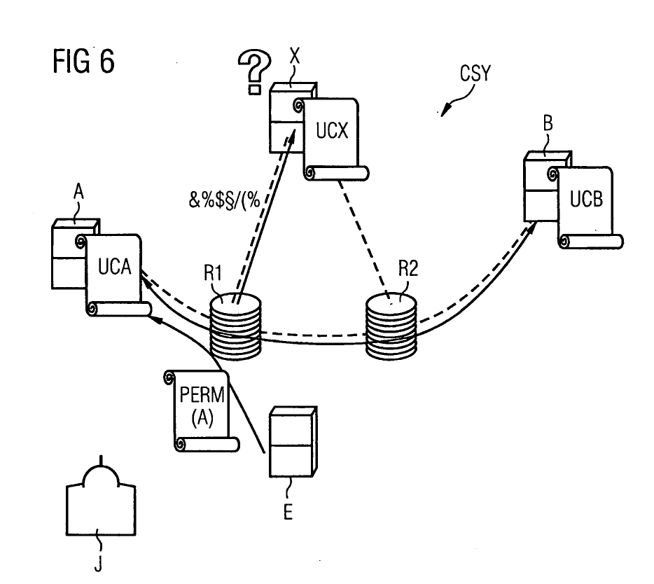

FIG. 6: a structural diagram for the schematic representation of an intercepted exchange of messages in a third phase.

FIG. 1A and FIG. 1B were already explained in the introduction to the description.

In one example of an embodiment, it is assumed that a service provider or network operator who is responsible for the performance of the legal tapping cooperates suitably with the manufacturer of the network element software or terminal or software clients. In addition, all the messages in the packet-oriented network in question here administered by the service provider to or from an intercepted network element are routed via an intermediary network element, for example a network node unit, to an executive authority. Intermediary network elements of this kind are anyway always present in a packet-oriented network so that this assumption is not an indispensable prerequisite for the method according to the invention.

The tapping mode according to the invention takes place as follows.

Usually, depending upon the legal situation in the place of use, special bodies—in particular courts—are provided which are the only bodies competent to order locking-on or legal interception. An executive authority, such as, for example, a police investigation agency, usually requires a previous court order to obtain authorization for locking-on. In exceptional cases, in particular in the case of “Imminent Danger”, the executive authority is also permitted to perform a measure of this kind without a court order.

In an advantageous embodiment of the invention, it is proposed that courts receive certificates from a certificate issuer, entitling them to issue tapping licenses. Then, if a competent executive authority needs to tap the communications of a user, it must first obtain a permit from the competent court. This permit is issued in the form of a message signed by the competent court. This message preferably lays down who may be tapped, for how long and by whom. The certificate of the competent court authorizing the executive authority to perform locking-on must be either enclosed or integrated during production.

The message specifies the identity of the tapped entity, the period of the tapping and the public key of the tapping authority. The authority P can then send this message to the network element to be tapped and thereby switch it to tapping mode for the specified duration.

When the specified period comes to an end, the internal logic of the network element automatically returns to a normal operating mode. Optionally and depending on the telecommunications laws, it may be provided that, by means of the internal logic of the network element, after the expiration of a certain time, the tapped user receives a message that he was tapped.

Optionally, measures are taken to prevent the manipulation of the system time of the network element by the user in question.

The method described in more detail below ensures that neither the executive authority nor third parties can perform unauthorized tapping.

A further embodiment relates to additional messages generated by the tapped network element during the tapping process in order to notify the keys used to the executive authority. In one embodiment, these messages can be sent directly to the address of a network element available to the executive authority. However, for this, the network address or IP address must be made known to the tapped network element. However, this notification could be detected and the transmission of messages to the executive authority blocked by the settings on a firewall assigned to the network element in question. It is therefore proposed that messages of this kind should be generally sent to a central network element administered by the service provider, such as, for example a gatekeeper, rendezvous server, charging server, etc. Network elements also usually communicate with central network elements of this kind so that a sent message does not give rise to any suspicion in a user of a tapped network element. This is followed by routing to the executive authority from this central network element.

However, these measures should only be considered in exceptional cases, since, as already explained, in a packet-oriented network of a usual size, network nodes are in any case arranged throughout the network to distribute the entire network traffic of the tapped network element, and tapped messages are hence inevitably also routed to the tapping body.

The following describes with reference to FIG. 2 a preferred embodiment of the method according to the invention which is primarily for a non-real-time communication method. In the case of a confidential communication method to be established or already established as shown in FIGS. 1A and 1B a (not shown) network element to be tapped encrypts communication data(PLD) during the transmission of a message MSG3 with a session key SK1. The result of this encryption is depicted as EsK1 (PLD) in the drawing. However, unlike the method according to FIG. 1A and FIG. 1B, the session key SK1 is encrypted not only with the public key QB of the (not shown) receiving network element B, but also with the public key Qp of the executive authority.

The encrypted contents are shown in the diagram as

E_{QB}(SK1) and E_{QP}(SK1).

As soon as this message MSG3 reaches a (not shown) router of the (not shown) service provider, this additional part can be separated out of the message, so that the recipient receives a message identical to the first message in FIG. 1A, therefore a message which does not differ from a message MSG1 with which the sender is not subject to locking-on.

The tapping authority receives from the router a copy of the message which it can decrypt with a (not shown) private key assigned to it.

The following describes with reference to FIG. 3A the reception by the authorities of a message MSG5 to a tapped recipient A. This case is slightly more complicated since the non-tapped transmitter B cannot and must not know about the tapping process, i.e. as with the second message MSG2 in FIG. 1B, transmitter B sends messages with which the session key SK2 contained therein is still only encrypted with the public key QA assigned to the recipient A.

A copy of this message MSG5 is also routed to the network element assigned to the executive authority. However, the executive authority cannot yet decrypt the routed message MSG5. This decryption can take place as soon as, after the reception of a message, the tapped network element A encrypts the session key SK2 used therein with the public key Q_{P} of the executive authority and, according to the method according to the invention, see FIG. 3B, sends a correspondingly generated message MSG5 to the executive authority. The executive authority can now also decrypt the previous message MSG4 received from the tapped network element. The sixth message shown in FIG. 3C is an optional, abbreviated form of the fifth message MSG5 in FIG. 3B, which is also used for the decryption of the previous message MSG4 received from the tapped network element.

Blocking of these messages MSG5,MSG6 or the (not shown) message for the activation of the tapping mode by means of a firewall or similar means on the part of the tapped user is not really possible since the IP addresses characterizing the target and the sender make it difficult to distinguish these messages and their content from other signaling messages. Said signaling messages are also preferably transmitted encrypted. However, if there is a general blocking of all signaling messages, the user prevents further use of services offered by the service provider.

The following describes a preferred embodiment of the method according to the invention, which is primarily used for a real-time communication method. With this method of communication, preferably a Diffie-Hellman method as described in the introduction to the description is used. In addition, a secret random number of the tapped communication user, or, alternatively, directly the negotiated session key SK1, is encrypted with the public key Q_{P} of the executive authority. This information is appended outside the signed part of the message so it may be removed by the router during the forwarding to the receiving communication user. In other words, with this embodiment of the method according to the invention, the result of an encryption of the session key with a public key assigned to the third network element is not inserted in the message, but added to the message. FIGS. 4 to 6 are a schematic representation of the course of a legal interception according to the method according to the invention.

FIG. 4 shows a communication system CSY which comprises as a transmission medium a packet-oriented network, in particular with peer-to-peer-architecture. A user of a first network element A communicates via a first intermediary network node R1 and a second intermediary network node R2 with a user of a second network element B. A third user of a third network element X does not participate in this communication. All users of a network node A,B,X, or in the parlance used here, all network nodes A,B,X, are assigned their own certificate UCA,UCB,UCX.

The third user of the third network element X attempts to tap a communication between the network elements depicted by lines. The sequence of characters depicted in the drawing “&%$§/(%” on a communication path leading to the third network element X symbolizes that, without knowledge of a suitable key, the third network element X cannot obtain any knowledge of the content of the message exchanged.

The following describes with further reference to the functional units in FIG. 4 a configuration of a legal interception by an executive authority E. Hereby, identical reference characters in different figures represent identical functional elements.

The executive authority E receives from a competent court J a judicial tapping permit PERM(A) in the form of a signed message. This permit PERM(A) is sent by the executive authority E to the network element A to be intercepted which then switches to a tapping mode. In this mode, according to the statements above, the network element A notifies the executive authority E of the symmetrical key or session key for all incoming and outgoing messages. Following this, only the executive authority E can tap the network element A.

1.-14. (canceled)

15. A method for locking on to an encrypted communication connection, comprising:
providing a packet-oriented communication system;
using an end-to-end encryption for a communication between a first network element and a second network element;
establishing a session key between the first network element and the second network element;
encrypting a message content with the session key;
encrypting the session key with a public key assigned to the second network element;
creating a message comprising the encrypted message content and the encrypted session key;
transmitting the message from the first network element to the second network element;
switching to a tapping mode by the first network element based upon a prompting of a third network element; and
encrypting the session key with a public key assigned to the third network element.

16. The method as claimed in claim 15, wherein the session key encrypted based upon the public key of the third network element is introduced into the message.

17. The method as claimed in claim 15, wherein the session key encrypted based upon the public key of the third network element is added to the message.

18. The method as claimed in claim 15, wherein a certificate is requested to switch to a tapping mode in the first network element.

19. The method as claimed in claim 18, wherein the certificate is transmitted from the third network element to the first network element.

20. The method as claimed in claim 18, wherein the certificate contains a value characterizing a time of locking-on.

21. The method as claimed in claim 19, wherein the certificate is transmitted with a signature of a body authorizing the locking-on.

22. The method as claimed in claim 15, wherein a result of the encryption of the session key with the public key assigned to the third network element is extracted at an intermediary network element after the transmission of the message, and wherein the result is analyzed in the third network element.

23. The method as claimed in claim 22, wherein the intermediary network element is a router.

24. The method as claimed in claim 15, wherein the establishment of the session key is based on defining the session key by the first network element and based on transmitting the session key to the second network element.

25. The method as claimed in claim 15, wherein the establishment of the session key is based upon a negotiation between the first and the second network element.

26. The method as claimed in claim 25, wherein the negotiation is performed using a Diffie-Hellman method.

27. The method as claimed in claim 15, wherein the packet-oriented communication system is at least partly based on a peer-to-peer-architecture.

28. The method as claimed in claim 15, wherein a certificate is requested to switch to a tapping mode in the first network element, and wherein a result of the encryption of the session key with the public key assigned to the third network element is extracted at an intermediary network element after the transmission of the message, and wherein the result is analyzed in the third network element.

29. The method as claimed in claim 28, wherein the establishment of the session key is based on defining the session key by the first network element and based on transmitting the session key to the second network element.

30. The method as claimed in claim 28, wherein the establishment of the session key is based upon a negotiation between the first and the second network element, and wherein the packet-oriented communication system is based on a peer-to-peer-architecture.

31. A network element, comprising:
an encryption device for an end-to-end encryption;
an establishing system to establish a session key for an encrypted communication with a further network element;
a changing device to change the network element into a tapping mode; and
an attaching device to attach an encryption of the session key with a public key assigned to a third network element.

32. A network element, comprising:
an encrypted communication connection to a packet-oriented communication system;
a session key for a communication between the network element and a second network element;
a second public key assigned to the second network element;
a third public key assigned to a third network element; and
a message comprising an encrypted message content based on the session key, an encrypted session key based on the second public key, and an encrypted session key based on the third public key.

33. The network element as claimed in claim 32, further comprising a certificate received from the third network element to approve a tapping mode of the network element.

34. The network element as claimed in claim 32, wherein the network element is a mobile network element.
